(19) United States
(12) Patent Application Publication
(10) Pub. No.: US 2014/0163913 A1
(43) Pub. Date: Jun. 12, 2014

(54) DETERMINING THE DOPANT CONTENT OF A COMPENSATED SILICON SAMPLE

(71) Applicants: Sebastien Dubois, Scionzier (FR); Nicolas Enjalbert, Burlats (FR); Jordi Veirman, Poisy (FR)

(72) Inventors: Sebastien Dubois, Scionzier (FR); Nicolas Enjalbert, Burlats (FR); Jordi Veirman, Poisy (FR)

(73) Assignee: COMMISSARIAT A L'ENERGIE ATOMIQUE ET AUX ENERGIES ALTERNATIVES, Paris (FR)

(21) Appl. No.: 14/235,218

(22) PCT Filed: Jul. 20, 2012
(86) PCT No.: PCT/FR2012/000299

§ 371 Date: Jan. 27, 2014

(30) Foreign Application Priority Data
Jul. 27, 2011 (FR) 1102354

(51) Int. Cl. G01N 27/04

(52) U.S. Cl. CPC G01N 27/041
USPC 702/65

(57) ABSTRACT

The method for determining the concentrations of dopant impurities in a silicon sample includes provision of a silicon ingot including donor-type dopant impurities and acceptor-type dopant impurities, a step for determining the position of a first area of the ingot in which a transition takes place between a first conductivity type and a second opposite conductivity type, a step for measuring the concentration of free charge carriers in the second area of the ingot, distinct from the first area, by Hall effect, Fourier transform infrared spectroscopy or a method using the lifetime of the charge carriers, and a step for determining the concentrations of dopant impurities in the sample from the position of the first area and the concentration of free charge carriers in the second area of the ingot.

### BACKGROUND OF THE INVENTION

The invention relates to determination of the dopant contents in a silicon sample, and more particularly in an ingot designed for the photovoltaic industry.

### STATE OF THE ART

Upgraded Metallurgical Grade Silicon (UMG-Si) is generally compensated in dopant impurities. Silicon is said to be compensated when it contains both types of dopant impurities: electron acceptors and donors.

According to the concentrations of acceptor dopants N_{A} and donor dopants N_{D}, several compensation levels can be defined, perfect compensation being obtained for N_{A}=N_{D}. Typically, the impurities of acceptor type are boron atoms and the impurities of donor type are phosphorus atoms.

FIG. 1 represents the boron concentration [B] and the phosphorus concentration [P] versus the position h in a metallurgical grade silicon ingot.

As both types of impurities are present simultaneously, the conductivity type of the silicon is determined by the impurity having the greater concentration. In the bottom part of the ingot (low h), the concentration of boron atoms is greater than the concentration of phosphorus atoms and the silicon is then of p-conductivity type. In the top part on the other hand, the phosphorus concentration exceeds the boron concentration. The silicon is then of n-conductivity type.

At a height h_{eq}, the ingot thus presents a change of conductivity type, from p-type to n-type in the example of FIG. 1. At this height, the boron and phosphorus concentrations are equal ([B]ₕ_{_{eq}}=[P]ₕ_{_{eq}}, which means that the silicon is perfectly compensated.

Fabrication of photovoltaic cells from UMG-Si wafers requires stringent control of the dopant contents. The acceptor dopant and donor dopant

Fabrication of photovoltaic cells from UMG-Si wafers requires stringent control of the dopant contents. The acceptor dopant and donor dopant concentrations do in fact influence the electric properties of the cells, such as the conversion efficiency.

It therefore appears important to know the dopant concentrations in a silicon ingot, in particular to determine whether additional purification steps are necessary. It is also useful to know the dopant concentrations in the silicon feedstock used for fabricating the ingot. This information then enables the photovoltaic cell fabrication methods to be optimized.

Determination of the dopant concentrations is generally performed by the silicon ingot supplier, on completion of crystallization of the latter. Various different techniques can be used.

Patent application CA2673621 describes a method for determining the dopant concentrations in a compensated silicon ingot. The electric resistivity is measured over the height of the ingot to detect the transition between a p-conductivity and an n-conductivity. This transition does in fact result in a resistivity peak. The boron and phosphorus concentrations at the p-n junction are then calculated from the value of the resistivity at the junction and from an empirical relation. The dopant concentrations in the whole of the ingot can then be deduced therefrom by means of Scheil's equation.

The article “Segregation and crystallization of purified metallurgical grade silicon: Influence of process parameters on yield and solar cell efficiency” (B. Drevet et al., 25^{th} European PV Solar Energy Conference and Exhibition, Valencia, 2010) describes another technique for determining the dopant concentrations. The height h_{eq} of the change of conductivity type is first determined. Then the electric resistivity ρ is measured, as in the document CA2673621. However, it is not measured at the p-n transition but at the bottom end of the ingot, i.e. in the area corresponding to the beginning of solidification. The parameters h_{eq} and ρ are then input to a Scheil's equation to determine the concentration profiles in the ingot.

These techniques, based on a resistivity measurement, are however not satisfactory. Large differences are in fact observed between the dopant concentration values obtained with these techniques and the expected values.

### SUMMARY OF THE INVENTION

It is observed that a requirement exists to provide a method that is precise and easy to implement for determining the concentrations of dopant impurities in a compensated silicon sample.

This requirement tends to be satisfied by means of the following steps:
providing a silicon ingot comprising dopant impurities of donor type and dopant impurities of acceptor type;
determining the position of a first area of the ingot in which a transition takes place between a first conductivity type and an opposite second conductivity type;
measuring the free charge carrier concentration in a second area of the ingot, different from the first area, by Hall effect or by Fourier transform infrared spectroscopy; and
determining the concentrations of dopant impurities in the sample from the position of the first area and the free charge carrier concentration in the second area of the ingot.

In a preferred embodiment, the second area is an end of the ingot representative of a beginning of solidification.

According to a development, the position of the first area of the ingot is obtained by subjecting portions of the ingot to chemical treatment based on hydrofluoric acid, nitric acid, and acetic or phosphoric acid, enabling defects to be revealed on one of the portions corresponding to the transition between the first conductivity type and the second conductivity type, and by determining the position in the ingot of the portion presenting the defects.

In an alternative embodiment of the method, the silicon ingot comprises boron atoms and oxygen atoms, and the concentration of free charge carriers in a second area of the ingot, of p-conductivity type, is obtained by monitoring the variation under light exposure of the lifetime of the charge carriers.

### BRIEF DESCRIPTION OF THE DRAWINGS

Other advantages and features will become more clearly apparent from the following description of particular embodiments of the invention given for non-restrictive example purposes only and represented in the appended drawings, in which:

FIG. 1, described in the above, represents conventional dopant concentration profiles along a compensated silicon ingot;

FIG. 2 represents steps of a method for determining the dopant concentrations in the ingot according to a preferred embodiment of the invention;

FIG. 3 represents the electric resistivity along the silicon ingot;

FIG. 4 represents different wafers originating from the silicon ingot, after a chemical polishing step; and

FIG. 5 represents the lifetime under light exposure of the charge carriers in the ingot versus the exposure time.

### DESCRIPTION OF A PREFERRED EMBODIMENT OF THE INVENTION

A method for determining the concentrations of dopant impurities in a compensated silicon sample, based on measurement of the charge carrier concentration q rather than measurement of the resistivity, is proposed here. Concentration q is measured by Hall effect, by Fourier Transform Infrared Spectroscopy (FTIR), by measurement of the C-V characteristics or by a technique using the lifetime under light exposure of the charge carriers. From the concentration q and the position h_{eq} of the p-n transition (or n-p transition if this is the case) in the ingot, the acceptor and donor dopant concentrations of the sample can be calculated precisely.

By definition, the silicon ingot comprises dopant impurities of acceptor type and of donor type. A dopant impurity can be constituted by a single atom or by a cluster of (complex) atoms, such as thermal donors. In the following description, the example of a boron atom as acceptor-type impurity and of a phosphorus atom as donor-type impurity will be taken. Other dopants could however be envisaged, such as arsenic, gallium, antimony, indium, etc.

The ingot is preferably pulled by means of the Czochralski method. The area corresponding to the beginning of solidification will henceforth be referred to as “bottom of the ingot” or “foot of the ingot” and the height will designate the dimension of the ingot along the solidification axis. In particular, the height h_{eq} of the p-n transition will be calculated with respect to the bottom of the ingot and will be expressed in percentage of its total height (relative height).

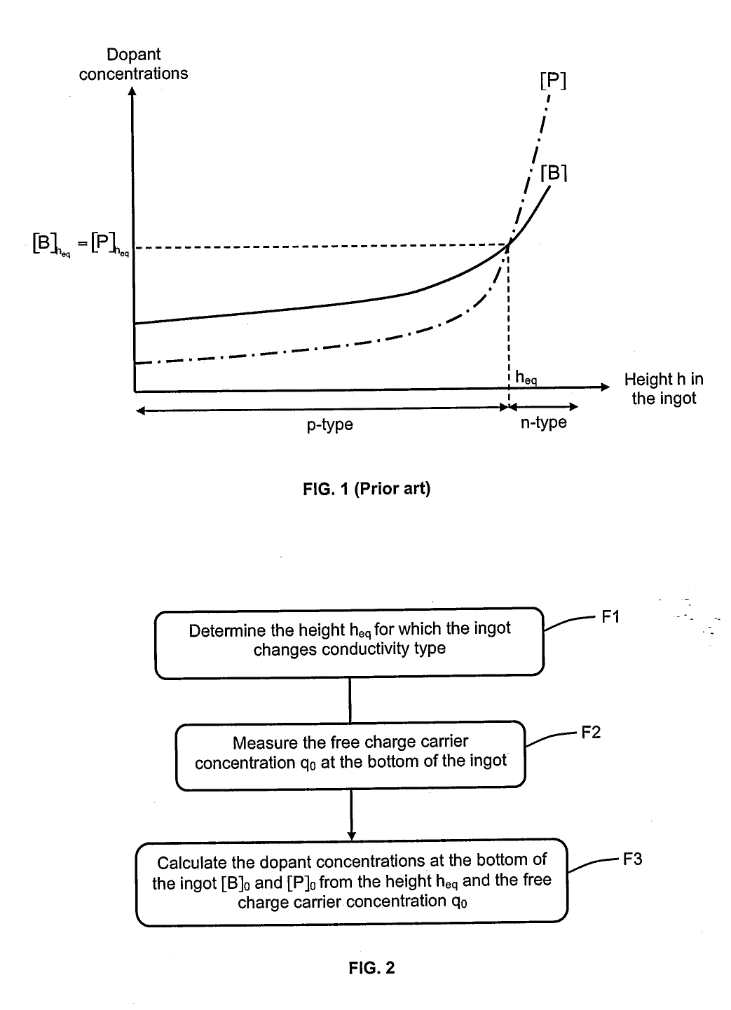

FIG. 2 represents steps of a preferred embodiment of the determining method.

In a first step F1, the height h_{eq} of the ingot is determined for which a change of conductivity type is observed, for example from p-type to n-type (FIG. 1). Several techniques enabling the p-n transition to be detected are described in detail in the following.

A first technique consists in measuring the electric resistivity at different heights of the ingot.

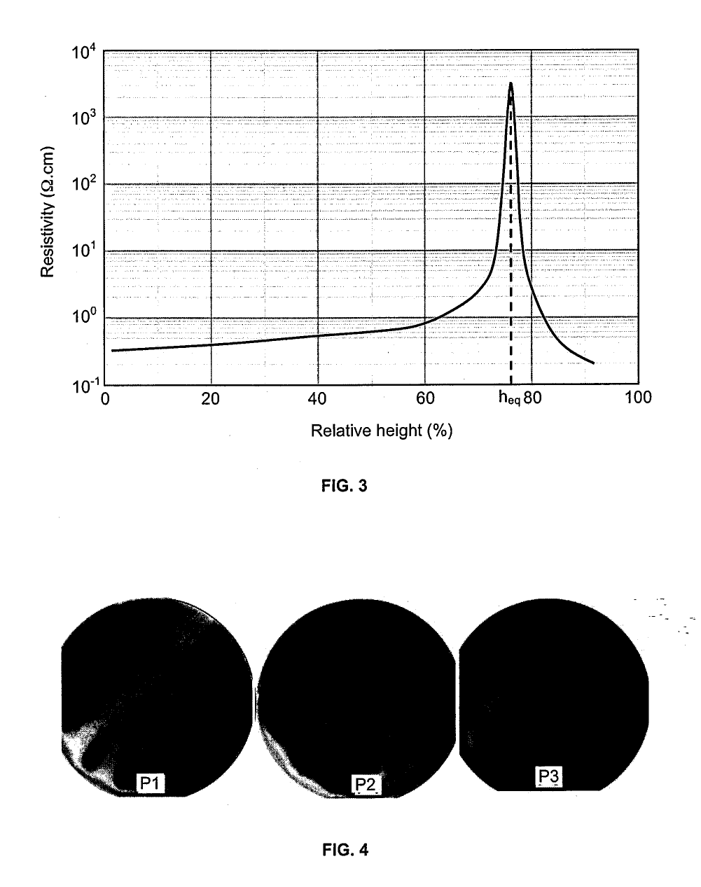

FIG. 3 is an example of measurement of the electric resistivity versus the relative height in a compensated silicon ingot. A resistivity peak appears at about 76% of the total height of the ingot.

This peak can be attributed to the change of conductivity type obtained when the silicon is perfectly compensated. Indeed, as the phosphorus concentration [P] progressively approaches the boron concentration [B] (FIG. 1), the number of free charge carriers tends to zero. This is due to the fact that the electrons provided by the phosphorus atoms compensate the holes provided by the boron atoms. The resistivity then increases greatly. Once equilibrium has been reached, for [B]_{heq}=[P]_{heq}, the resistivity decreases as the number of charge carriers (electrons) increases.

The abscissa of the resistivity peak therefore corresponds to the position h_{eq} of the change of conductivity type in the ingot. In this example, h_{eq} is equal to 76%.

Resistivity measurement can be performed in simple manner by the four-points probes method or by a contact-free method, for example by inductive coupling.

A second technique consists in measuring the conductivity type directly over the height of the ingot. Determination of the conductivity type is based on the surface photo voltage (SPV) measurement method. The principle of such a measurement is as follows. A laser is applied periodically on the surface of the ingot, which will temporarily generate electron-hole pairs. Capacitive coupling between the surface of the ingot and a probe enables the surface voltage to be determined.

The difference between the surface potential under illumination and the surface potential in darkness, and more particularly the sign of this difference, enables the conductivity type in the examined area of the ingot to be determined. Measurement of the type de conductivity by the SPV method is for example formed by means of the PN-100 equipment marketed by SEMILAB.

In the case of the ingot of FIG. 3, measurement of the conductivity type indicates a change from p-type to n-type at about 76% of the total height of the ingot.

Another technique, based on chemical polishing, can be used to determine h_{eq} in a single-crystal silicon ingot obtained by the Czochralski method. Several portions of the ingot are immersed in a bath containing acetic acid (CH₃COOH), hydrofluoric acid (HF) and nitric acid (HNO₃). The processing time varies according to the temperature of the bath. It is preferably comprised between 1 min and 10 min. For example purposes, the chemical bath comprises three volumes of an acetic acid solution at 99% and three volumes of a nitric acid solution at 70%, for one volume of hydrofluoric acid at 49%. Phosphoric acid (H₃PO₄) can also replace the acetic acid.

The inventors observed that, on completion of such a step, the most resistive portion of the ingot, i.e. the portion where the p-n transition takes place, presents crystallographic defects in the form of concentric circles or ellipses called swirls. The position of this area in the ingot then corresponds to the height h_{eq}.

Advantageously, the ingot is diced into a plurality of wafers, for example with a diamond saw, and the wafers are then subjected to the chemical treatment.

FIG. 4 contains three photographs of wafers that have undergone the chemical polishing step. It can be observed that wafer P2, in the centre, presents crystallographic defects at the surface. Wafer P2 therefore originates from the transition area of the ingot. Wafers P1 and P3 are representative of the areas of the ingot respectively situated before and after the change of conductivity type.

The chemical bath is preferably an aqueous solution only containing the above-mentioned three acids. In other words, it is formed by water, nitric acid, hydrofluoric acid, and acetic or phosphoric acid. With a bath devoid of any other chemical species, such as metals, contamination of the silicon wafers which would make them unusable for certain applications (in particular photovoltaic) is prevented.

In step F2 of FIG. 2, the charge carrier concentration q₀ is measured in an area of the ingot, distinct from the transition area. In this preferential embodiment, measurement is performed at the foot of the ingot, which simplifies subsequent calculation of the dopant concentrations (step F3). Different techniques can be used.

Measurement by Hall effect, used in the article “Electron and hole mobility reduction and Hall factor in phosphorus-compensated p-type silicon” (F. E. Rougieux et al., Journal of Applied Physics 108, 013706, 2010), enables the charge carrier concentration q₀ in a compensated silicon sample to be determined.

This technique first of all requires preparation of the silicon sample. For example, a silicon wafer with a thickness of about 450 μm is taken off from the bottom end of the ingot. Then a bar with a surface of 10×10 mm² is cut by laser in the wafer. Four InGa electric contacts are formed on the sides of the bar.

Measurement by Hall effect is preferably performed at ambient temperature. It enables the Hall carrier concentration q_{0H} to be obtained, by means of which q₀ can be calculated using the following relation:

q₀=r_{H}×q₀_{_{H}}.

The Hall factor r_{H}, taken from the above-mentioned article, is about equal to 0.71 in compensated silicon.

In the ingot corresponding to FIG. 3, the value of q_{0H} obtained is about 1.5*10¹⁷ cm⁻³, i.e. a charge carrier concentration q₀ at the bottom of the ingot of about 9.3*10¹⁶ cm⁻³.

Alternatively, the charge carrier concentration q₀ can be measured by Fourier transform infrared spectroscopy (FTIR). The FTIR technique measures the absorption of an infrared radiation in the silicon versus the wavelength λ of this radiation. The dopant impurities, as well as the charge carriers, contribute to this absorption. It has however been shown in the article “Doping concentration and mobility in compensated material: comparison of different determination methods” (J. Geilker et al., 25^{th} European PV Solar Energy Conference and Exhibition, Valencia, 2010) that absorption by the charge carriers varies as a function of λ² and of φ₀². By measuring the absorption on the FTIR spectra, a value of q₀ can thus be deduced therefrom.

Unlike measurement by Hall effect, FTIR measurement is contact-free and can be applied directly on the silicon ingot.

Concentration q₀ can also be determined by the C-V (Capacitance-Voltage) measurement method. This measurement requires preparation of a silicon sample taken at the bottom of the ingot. A gate, for example made from metal, is deposited on the sample so as to create a MOS capacitance. The electric capacitance is then measured according to the voltage applied on the gate. As described in the article “Determination of the base dopant concentration of large area crystalline silicon solar cells” (D. Hinken et al., 25^{th} European PV Solar Energy Conference and Exhibition, Valencia, 2010), the derivative of the squared capacitance C(V) is proportional to q₀:

$$\frac{\partial ( \frac{1}{{C}^{2}} )}{\partial V} ∝ {q}_{0}$$

By measuring the slope of the plot of 1/C² versus V, q₀ can be determined.

In the case of a boron-doped ingot comprising oxygen atoms, a last technique could be envisaged to determine q₀ consisting in activating boron-oxygen complexes by illuminating the bottom of the ingot. The energy input in the form of photons does in fact modify the spatial configuration of the complexes formed when crystallization takes place.

Determination of q₀ involves the use of a model describing the activation kinetics under illumination of these boron-oxygen complexes. The model is as follows.

The article “Kinetics of the electronically stimulated formation of a boron-oxygen complex in crystalline silicon” (D. W. Palmer et al., Physical Review B 76, 035210, 2007) shows that the concentration N*ᵣₑₗ of the boron-oxygen complexes activated in a crystalline silicon varies in exponential manner with the exposure time t to light:

N*ᵣₑₗ(t)=exp(−R_{gen}t) (1)

R_{gen} is the generation rate of these complexes, given by the following relation:

$${R}_{gen} = {κ}_{0} \cdot exp ( \frac{- {E}_{a}}{{k}_{B} T} ) \qquad ( 2 )$$

E_{A} being the activation energy (E_{A}=0.47 eV), k_{B} the Boltzmann's constant and T the temperature of the ingot (in Kelvin).

In a silicon doped only with boron, the term κ₀ is proportional to the square of the concentration of boron atoms (κ₀=A·[B]₀²) according to the article by Palmer et al.

In the case of compensated silicon on the other hand, the concentration of boron atoms [B]₀ has to be replaced by the net doping, i.e. the difference between the boron and phosphorus concentrations [B]₀[P]₀. This net doping is equivalent to the charge carrier concentration q₀.

A relation between the generation rate R_{gen} of the boron-oxygen complexes and the charge carrier concentration q₀ can then be deduced therefrom:

$${R}_{gen} = A \cdot {q}_{0}^{2} \cdot exp ( \frac{- {E}_{a}}{{k}_{B} T} ) \qquad ( 3 )$$

A is a constant equal to 5.03*10⁻²⁹ s⁻¹.cm⁶.

Thus, to determine q₀, the concentration N*ᵣₑₗ of the boron-oxygen complexes at a given time is measured and relations (1) and (2) are then used.

The concentration N*ᵣₑₗ can be obtained by measuring the variation of the lifetime T of the charge carriers in the course of time. N*ᵣₑₗ and τ are in fact linked by the following relations:

$$\begin{matrix}{N}_{rel}^{*} ( t ) = \frac{{N}^{*} ( ∞ ) - {N}^{*} ( t )}{{N}^{*} ( ∞ )} \\ and & ( 4 ) \\ {N}^{*} ( t ) = \frac{1}{τ ( t )} - \frac{1}{{τ}_{0}} & ( 5 )\end{matrix}$$

where τ₀ is the lifetime of the carriers before exposure and N*(∞) is the limit (and maximum) value of N*(t), i.e. the concentration of boron-oxygen complexes when all the complexes have been activated. N*ᵣₑₗ is in fact a relative concentration of the boron-oxygen complexes.

The lifetime measurements are preferably performed by the IC-QssPC technique, the IC-PCD technique or the μW-PCD technique. These techniques being conventional, they will not be dealt with in detail in this application.

The silicon ingot is preferably subjected to a white light of an intensity comprised between 1 mW/cm² and 10 W/cm² and the temperature of the ingot is comprised between 0° C. and 100° C. The white light source is for example a halogen lamp or a xenon lamp.

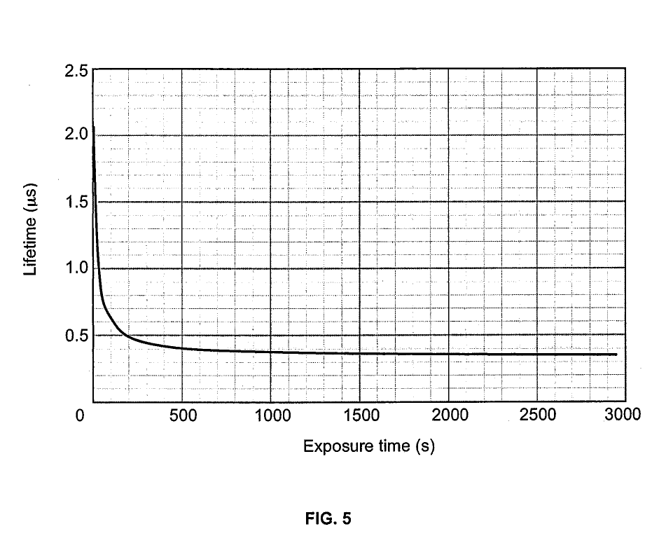

FIG. 5 is a plot of the lifetime τ of the carriers versus the exposure time to the white light, at the bottom of the silicon ingot. In this example, the temperature of the silicon is 52.3° C. and the light intensity is about 0.05 W.cm⁻².

From this curve plot, it is possible to calculate the relative concentration N*ᵣₑₗ of the boron-oxygen complexes and deduce the concentration q₀ therefrom (relations 1 to 5). The value of q₀ obtained with this technique is about 6.310¹⁶ cm⁻³.

Monitoring under illumination of the lifetime τ of the carriers can be continuous, as in the case of FIG. 5, or discontinuous, provided that the wafer or the ingot is in darkness during the stopping period between the two lifetime measurement periods.

In an alternative embodiment, the concentration N*ᵣₑₗ is determined by means of measurement of the diffusion length L_{D} of the charge carriers, which depends directly on their lifetime:

$$τ ( t ) = \frac{μ}{{L}_{D}^{2} ( t )} .$$

The values of L_{D} can be obtained from Light Beam Induced Current (LBIC) mapping. The term μ is the mobility of the carriers in the sample. It is not however required to be known, as it is simplified in equation (4).

The technique associated with activation of the boron-oxygen complexes, via lifetime or diffusion length measurements, is simple to implement. It does not in fact require any sample preparation, unlike measurement by Hall effect. Furthermore, it is contact-free and can therefore be applied directly on a p-type area of the ingot.

Preferably, the ingot is devoid of impurities other than the dopants (donors and acceptors) and oxygen. In particular, it is advantageous for the ingot to be devoid of iron.

The techniques for determining the concentration q₀ described above (step F2) could be used with any one of the techniques for determining the height h_{eq} (F1). Step F2 could also be performed before step F1.

Step F3 of FIG. 2 corresponds to calculation of the boron and phosphorus concentrations at the bottom of the ingot from the height h_{eq} determined in step F1 and the concentration q₀ measured in step F2. This calculation is based on Scheil-Gulliver's law which describes the variation of the boron and phosphorus concentrations in the ingot in the following manner:

[B]ₕ=[B]₀(1−h)^{k}^{_{B}}⁻¹ (6),

[P]ₕ=[P]₀(1−h)^{k}^{_{P}}⁻¹ (7).

[B]ₕ and [P]ₕ are the boron and phosphorus concentrations at any height h of the ingot. [B]₀ and [P]₀ designate the boron and phosphorus concentrations at the bottom of the ingot. Finally, k_{B} and k_{P} are respectively the sharing coefficients of the boron and of the phosphorus, also called segregation coefficients (k_{B}, k_{P}<1).

At the height h_{eq}, the silicon is perfectly compensated. The following relation is deduced therefrom:

[B]ₕ_{_{eq}}=[P]ₕ_{_{eq}} (8).

By replacing [B]ₕ_{_{eq}} and [P]ₕ_{_{eq}} by expressions (6) and (7), relation (8) becomes:

[B]₀(1−h_{eq})^{k}^{_{B}}⁻¹=[P]₀(1−h_{eq})^{k}^{_{P}}⁻¹ (9).

Furthermore, the concentrations of boron [B]₀ and phosphorus [P]₀ at the bottom of the ingot are linked by the following relation:

[B]₀−[P]₀=q₀ (10).

Relation (10) is valid in the case of a p-type at the bottom of the ingot. In the case of an n-type, obtained with phosphorus and gallium for example, the opposite relation will be taken:

[P]₀−[B]₀=q₀ (10′).

By solving the system of equations (9) and (10), the expression of the [B]₀ and [P]₀ concentrations as a function of h_{eq} and q₀ is obtained:

$$\begin{matrix}{[ B ]}_{0} = \frac{{{q}_{0} ( 1 - {h}_{eq} )}^{{k}_{P} - 1}}{{( 1 - {h}_{eq} )}^{{k}_{P} - 1} - {( 1 - {h}_{eq} )}^{{k}_{B} - 1}} , & ( 11 ) \\ {[ P ]}_{0} = {[ B ]}_{0} - {q}_{0} . & ( 12 )\end{matrix}$$

Relations (11) and (12) therefore enable the boron and phosphorus concentrations at the bottom of the ingot to be calculated from height h_{eq} of the p-n transition and charge carrier concentration q₀. The dopant concentrations in the whole of the ingot can then be calculated by means of relations (7) and (8).

It is further possible to directly calculate the initial boron and phosphorus concentrations in the silicon feedstock used for pulling the ingot. These concentrations, noted [B]_{C} and [P]_{C}, are deduced from relations (11) and (12) in the following manner :

$$\begin{matrix}{[ B ]}_{C} = \frac{{[ B ]}_{0}}{{k}_{B}} = \frac{1}{{k}_{B}} \frac{{{q}_{0} ( 1 - {h}_{eq} )}^{{k}_{P} - 1}}{{( 1 - {h}_{eq} )}^{{k}_{P} - 1} - {( 1 - {h}_{eq} )}^{{k}_{B} - 1}} , & ( 13 ) \\ {[ P ]}_{C} = \frac{{[ P ]}_{0}}{{k}_{P}} = \frac{{{k}_{B} [ B ]}_{C} - {q}_{0}}{{k}_{P}} . & ( 14 )\end{matrix}$$

In the case of the n-type at the bottom of the ingot, q₀ will be replaced by −q₀ in relations (11) to (14), in accordance with relation (10′).

Expressions (11) to (14) can be generalized to all the acceptor and donor dopants. To determine the concentration of acceptor dopants N_{A} and the concentration of donor dopants N_{D}, the sharing coefficients of the boron and of the phosphorus, k_{B} and k_{P}, simply have to be replaced by the coefficients of the acceptor and donor dopants used, k_{A} and k_{D}.

Table 1 below sets out the values of h_{eq} and q₀ obtained previously. The boron and phosphorus concentrations at the bottom of the ingot, [B]₀ and [P]₀, were calculated using relations (11) and (12), for two of the three techniques for determining q₀ envisaged in the foregoing: Hall effect and monitoring of the activation kinetics of the boron-oxygen complexes (designated “LID” in the table). For comparison purposes, table 1 indicates the expected values of the [B]₀ and [P]₀ concentrations (reference sample), as well as the values obtained by the prior art method (resistivity).

TABLE 1

| | h_{eq} (%) | q₀ (cm⁻³) | [B]₀ (cm⁻³) | [P]₀ (cm⁻³) |
|---|---|---|---|---|
| Expected values | | | 2.6 * 10¹⁷ | 1.2 * 10¹⁷ |
| Hall effect | 76 | 9.3 * 10¹⁶ | 1.9 * 10¹⁷ | 1.0 * 10¹⁷ |
| LID | 76 | 6.3 * 10¹⁶ | 1.3 * 10¹⁷ | 7.0 * 10¹⁶ |
| Resistivity | 76 | 4.9 * 10¹⁶ | 1.0 * 10¹⁷ | 5.4 * 10¹⁶ |

It can be observed that the values of the dopant concentrations obtained by means of the method of FIG. 2 (Hall effect, LID) are closer to the expected values than those obtained by the prior art method. Thus, by circumventing the resistivity when performing calculation of step F3, precise values of the boron concentration and of the phosphorus concentration in the compensated silicon ingot are obtained.

The method for determining the dopant contents has been described in relation with measurement of the charge carrier concentration at the bottom of the ingot (q₀). However, this concentration is able to be determined in any area of the ingot (q). Equations (6) to (14) will then be modified accordingly.

The method has been described with a single type of acceptor dopants, boron, and a single type of donor dopants, phosphorus. Several sorts of acceptor dopants and several sorts of donor dopants can however be used. A system with n equations will then be obtained (n being the number of unknowns, i.e. the number of different dopants). To solve this equation, n-1 measurements of the charge carrier concentration q will be made, at different heights of the ingot, and 1 measurement will be made of the height he_{q} at which equilibrium of the dopant concentrations is obtained (sum of the p-type dopant concentrations=sum of the n-type dopant concentrations).

1-7. (canceled)

8. A method for determining concentrations of dopant impurities in a silicon sample comprising the following steps:
providing a silicon ingot comprising dopant impurities of donor type, boron atoms and oxygen atoms;
determining a first area of the ingot in which a transition takes place between a first conductivity type and an opposite second conductivity type, the first area being associated with a first height position in the ingot;
measuring the free charge carrier concentration in a second area of the ingot, of p-type and different from the first area, by monitoring the variation under illumination of the lifetime of the charge carriers; and
determining the concentrations of dopant impurities in the sample from the first height position of the first area and the free charge carrier concentration in the second area of the ingot.

9. The method according to claim 8, comprising an activation step of boron-oxygen complexes by illumination of the silicon ingot.

10. A method for determining concentrations of dopant impurities in a silicon sample comprising the following steps:
providing a silicon ingot comprising dopant impurities of donor type and dopant impurities of acceptor type;
determining a first area of the ingot in which a transition takes place between a first conductivity type and an opposite second conductivity type, the first area being associated with a first height position in the ingot;
measuring the free charge carrier concentration in a second area of the ingot, different from the first area, by Hall effect or by Fourier transform infrared spectroscopy; and
determining the concentrations of dopant impurities in the sample from the first height position of the first area and the free charge carrier concentration in the second area of the ingot.

11. The method according to claim 8, wherein the second area is an end of the ingot representative of a beginning of solidification.

12. The method according to claim 11, wherein the concentration of acceptor-type dopant impurities N_{A} and the concentration of donor-type dopant impurities N_{D} at the end of the ingot are determined by means of the following relations:
$${N}_{A} = \frac{{{q}_{0} ( 1 - {h}_{eq} )}^{{k}_{D} - 1}}{{( 1 - {h}_{eq} )}^{{k}_{D} - 1} - {( 1 - {h}_{eq} )}^{{k}_{A} - 1}} and {N}_{D} = {N}_{A} - {q}_{0} ,$$
wherein q₀ is the free charge carrier concentration at the end of the ingot, h_{eq} is the first height position of the first area of the ingot, and k_{D} and k_{A} are respectively sharing coefficients of the donor and acceptor impurities.

13. The method according to claim 11, wherein the concentration of acceptor-type dopant impurities N_{A} and the concentration of donor-type dopant impurities N_{D} in a silicon feedstock used for formation of the ingot are determined by means of the following relations:
$${N}_{A} = \frac{1}{{k}_{A}} \cdot \frac{{{q}_{0} ( 1 - {h}_{eq} )}^{{h}_{D} - 1}}{{( 1 - {h}_{eq} )}^{{k}_{D} - 1} - {( 1 - {h}_{eq} )}^{{k}_{A} - 1}} and$$
$${k}_{D} {N}_{D} = {k}_{A} {N}_{A} - {q}_{0} ,$$
wherein q₀ is the free charge carrier concentration at the end of the ingot, h_{eq} is the first height position of the first area of the ingot, and k_{D} and k_{A} are respectively sharing coefficients of the donor and acceptor impurities.

14. The method according to claim 8, wherein the first height position of the first area of the ingot is obtained by means of the following steps:
subjecting portions of the ingot to chemical treatment based on hydrofluoric acid, nitric acid, and acetic or phosphoric acid, enabling defects to be revealed on one of the portions corresponding to the transition between the first conductivity type and the second conductivity type;
determining the height position in the ingot of the portion presenting the defects.

15. The method according to claim 10, wherein the second area is an end of the ingot representative of a beginning of solidification.

16. The method according to claim 15, wherein the concentration of acceptor-type dopant impurities N_{A} and the concentration of donor-type dopant impurities N_{D} at the end of the ingot are determined by means of the following relations:
$${N}_{A} = \frac{{{q}_{0} ( 1 - {h}_{eq} )}^{{k}_{D} - 1}}{{( 1 - {h}_{eq} )}^{{k}_{D} - 1} - {( 1 - {h}_{eq} )}^{{k}_{A} - 1}} and$$
$${N}_{D} = {N}_{A} - {q}_{0} ,$$
wherein q₀ is the free charge carrier concentration at the end of the ingot, h_{eq} is the first height position of the first area of the ingot, and k_{D} and k_{A} are respectively sharing coefficients of the donor and acceptor impurities.

17. The method according to claim 15, wherein the concentration of acceptor-type dopant impurities N_{A} and the concentration of donor-type dopant impurities N_{D} in a silicon feedstock used for formation of the ingot are determined by means of the following relations:
$${N}_{A} = \frac{1}{{k}_{A}} \cdot \frac{{{q}_{0} ( 1 - {h}_{eq} )}^{{k}_{D} - 1}}{{( 1 - {h}_{eq} )}^{{k}_{D} - 1} - {( 1 - {h}_{eq} )}^{{k}_{A} - 1}} and$$
$${k}_{D} {N}_{D} = {k}_{A} {N}_{A} - {q}_{0} ,$$
wherein q₀ is the free charge carrier concentration at the end of the ingot, h_{eq} is the first height position of the first area of the ingot, and k_{D} and k_{A} are respectively sharing coefficients of the donor and acceptor impurities.
